(19) United States
(12) Patent Application Publication
(10) Pub. No.: US 2010/0034469 A1
(43) Pub. Date: Feb. 11, 2010

(54) METHOD OF FAST SEARCHING AND RECOGNITION OF A DIGITAL IMAGE REPRESENTATIVE OF AT LEAST ONE GRAPHICAL PATTERN IN A BANK OF DIGITAL IMAGES

(75) Inventors: Simon Thorpe, St Felix Lauragais (FR); Nicolas Guilbaud, Toulouse (FR)

Correspondence Address: YOUNG & THOMPSON, 209 Madison Street, Suite 500, Alexandria, VA, 22314, US

(73) Assignee: SPIKENET TECHNOLOGY, Labege (FR)

(21) Appl. No.: 12/444,968

(22) PCT Filed: Oct. 10, 2007
(86) PCT No.: PCT/FR2007/001655

§ 371 Date: Apr. 9, 2009

(30) Foreign Application Priority Data
Oct. 11, 2006 (FR) 06.08904

(51) Int. Cl. G06K 9/68

(52) U.S. Cl. 382/218

(57) ABSTRACT

A method for searching for a digital image representing a graphical pattern generates the descriptor of an image as a 2D m×n matrix (m, n: whole numbers): resample digital image to produce normalized image of dimensions c.m×d.n (c, d: given whole numbers), process the normalized image in p processes, indexed 1-p (p: given whole number), producing p digital characteristic images (CI), each having m×n sub-images (SI), each S-I being c×d, each CI is reduced to m×n by replacing each SI by at least one representative value determined as a function of the c×d SI pixels, a selection function selects from p values, at least one value as selected value, each descriptor element (i, j), iε[l,m], jε[l,n] is allocated the processing index from which the CI is derived generating the reduced image including the selected value from the selection function applied to p pixels (i, j) of the P reduced images.

The invention relates to a method of fast searching and recognition of a digital image representative of at least one graphical pattern among a plurality of digital images, called a bank of digital images, for example among a stream of digital images, called a dynamic digital image bank.

The considerable growth in the volume of digital images generated every day in all areas of life and business has given rise to the problem of searching for a specific and relevant visual data element among the quantity of images available.

By way of example, if we consider only the Eutelsat digital broadcasting images, at least 100 terabytes of images are generated every day.

With the known methods, it is at present virtually impossible to check all of these images, for example in order to ensure that their content complies with the rules in force in the broadcasting country or is compatible with the type of audience at which a broadcast program is targeted.

Furthermore, there is at present no satisfactory automatic method for enabling an advertiser to check that his advertisement has been broadcast according to the provision of a contract concluded with a broadcaster. Nor is there any satisfactory method for enabling a program distributor to check that his programs have not been broadcast without his consent, or for enabling a manufacturer to check that his products have not been displayed on line by a retailer who has not been approved, or for enabling a businessman to ensure that his trademarks and/or logos have not been reproduced and broadcast without his authorization, etc.

In other words, there is no method or device which is automatic, robust, rapid, and usable by any person to detect a predetermined digital image comprising at least one graphical pattern among very large numbers of digital images, and more specifically among streams of images.

The known methods for searching for an image in an image bank typically comprise a step of allocating an image descriptor to the desired image, a step of allocating an image descriptor to each image in the image bank, and a step of comparing these descriptors in order to discover two identical or similar descriptors. The quality of this kind of method depends, for example, on the quality of the image descriptor chosen to represent an image and on the quality of the comparator chosen to compare two descriptors. Moreover, to enable such a method to be implemented, it is preferable for the descriptor of an image to be smaller than the image which it describes, so that the comparison of two descriptors is faster than a direct comparison between the images.

The descriptors can be semantic; in other words they can comprise a semantic description of the scenes portrayed by the images. This method is used by most Internet search engines, for example.

However, semantic descriptor methods are totally unsuitable for the recognition of an image in a 100 terabyte image stream such as that which is broadcast daily by the Eutelsat system.

Other methods generate image descriptors from data extracted directly from the images, such as a quantity representing the texture of the image, data representing the shape of the profiles of the objects present in the image, one or more histograms of one or more regions of the image, and so on.

These methods enable images to be processed without the need for a preliminary analysis of the images.

The quality of such a method is directly dependent on the quality of the descriptors generated. The larger the descriptor, the more capable it is of containing discriminatory data. Such a descriptor can therefore be robust to geometric distortions and photometric degradation. On the other hand, the size of a descriptor is inversely proportional to the speed of recognition of an image in an image bank. The quality of a descriptor is therefore dependent on these two incompatible parameters.

FR 2 845 186 describes a method for measuring the similarity between images, in which each image is segmented into a plurality of segments; these segments are divided into different classes, each class representing a predetermined orientation; a histogram of the segments for each orientation class is produced; and the histograms of two images are compared to provide a measurement of similarity.

In this method, the segments are extracted for each image by detecting the profiles of the image by the application of gradients, by refining the zones detected in this way in order to eliminate thick profiles, by conducting connectivity tests to eliminate isolated pixels, and by searching for and eliminating junctions of profile lines so as to obtain portions of straight lines.

These steps, which precede the production of the histograms and the comparison of these, require a large amount of computer time and memory. The descriptors which are generated are large and not suitable for rapid comparison with each other.

Such a method is therefore inappropriate for the processing of large image banks, for example the processing of large image banks by a consumer device, in other words a data processing device having standard technical characteristics and a standard configuration, with a 1 to 2 GHz processor, a random-access memory of about 512 MB, etc., of the type currently available in computer stores.

US 2006/0015495 describes a method for measuring similarities between images, in which each images is resized according to predetermined dimensions; each image is divided into a plurality of sub-images; N values are calculated for each sub-image, using N methods; for each of these methods, a statistical model is developed from the values obtained for the set of sub-images; and a measurement of similarity between images is provided by the measurement of the similarity between the statistical models.

This method also requires an amount of computing power which makes it unsuitable for a device intended for the general public.

In this context, one object of the invention is to propose a method for searching for and recognizing an image among a plurality of images which is extremely fast and does not require a large amount of computing power.

Another object of the invention is to propose a method for searching for and recognizing an image among a plurality of images which can be used with the aid of a microcomputer having standard technical characteristics, namely a 1 to 2 GHz processor, a random-access memory of about 512 MB, etc.

A particular object of the invention is to propose a method for searching for and recognizing an image among a plurality of images which can enable at least 30 million images to be processed per second on a microcomputer having a 2 GHz processor.

Another object of the invention is a method of searching and recognition of an image among a plurality of images which can be used to generate image descriptors requiring not more than 30 bytes per descriptor.

Another object of the invention is to propose a method of searching and recognition of an image among a stream of dynamic images.

Another object of the invention is to propose a method of searching and recognition of an image among a plurality of video sequences, where each sequence is composed of a plurality of digital images.

For this purpose, the invention proposes a method of fast searching and recognition of a predetermined digital image, called the searched-for image, representing at least one graphical pattern, among a plurality of digital images, called the image bank, in which:
an index, called the reference index, is associated with said searched-for image,
for each image of said image bank, an index, called the listed index, is associated with this image and is sent to an index list,
for each listed index in said index list,
   a measurement of the similarity, called the distance, between this listed index and said reference index is determined and sent to a comparator,
   said determined distance is compared with a predetermined threshold by said comparator in order to determine whether the image associated with this listed index is similar, according to said comparison threshold, to said searched-for image,
      wherein each index (listed and reference) is a two-dimensional matrix of dimension m×n, where m and n are predetermined whole numbers, generated by the following steps:
the digital image associated with this index is sent to a module for resampling this image, adapted to provide a digital image, called the normalized image, having dimensions c.m×d.n, where c and d are predetermined whole numbers,
said normalized image is sent to a module for processing this image, adapted to carry out p processes, indexed from 1 to p, on the normalized image by p predetermined mathematical operators, to provide p digital images, called characteristic images, p being a predetermined whole number, each characteristic image being composed of m×n sub-images, each sub-image having the dimensions c×d,
each characteristic image is reduced to provide an image, called the reduced image, having the dimensions m×n, said reduced image being generated by replacing each sub-image of this characteristic image with at least one value, called the representative value of this sub-image, determined as a function of the c×d pixels of this sub-image,
a function called the selection function is determined to enable at least one value, called the selected value, to be selected from p values,
each element (i,j), iε[1,m], jε[1,n] of this index is given the index of the process which produces the characteristic image from which is obtained the reduced image which comprises said value selected by said selection function applied to the p pixels (i,j) of the p reduced images.

Throughout this text, the term “searched-for digital image” denotes an image which comprises at least one specific predetermined searched-for graphical pattern. A method according to the invention makes it possible to search for and recognize in an image bank at least one digital image which comprises at least this graphical pattern. The digital image found by the method according to the invention may comprise the searched-for graphical pattern only, or may comprise additional patterns.

For each image, the index generated is used as a descriptor of this image.

The steps of generating the listed indices and the reference index, hereinafter referred to as the “indexing method”, enable indices to be generated rapidly without the need for a large amount of computing power. Experiments conducted by the inventors have also shown that such indices are not only simply and rapidly generated, but also provide very good discrimination between the images from which they are derived. Thus these indices make it possible to obtain results which are unequalled at the present time in terms of execution speed, number of images processed per second, discrimination capacity, robustness to photometric degradation, and ease of implementation.

The fundamental principle of index generation according to the invention is the allocation of a value representing a type of processing performed, instead of a value resulting from the processing performed, to each element of the index. An index according to the invention can therefore be stored in a microcomputer memory with a number of bits much smaller than the number of bits required to store a descriptor in the prior art. In particular, an element of an index according to the invention can take one value out of p possible values, whereas an element of a descriptor according to the prior art can generally take one value out of the set of values which may be taken by a pixel of the image associated with this descriptor. An index according to the invention can therefore be stored as (m×n)×log₂ p bits in memory. An index according to the invention can therefore be extremely compact. It also contains a highly discriminatory data element, this element representing the processing performed on the image associated with this index.

This makes it possible to develop a wide range of applications which would have been unthinkable before the present time. In particular, a method according to the invention makes it possible to scan all images broadcast every day on different media, such as satellite broadcast media, and can be used, in optics for example, in order to detect a specific image, to find trademarks and/or logos, or the like. A method according to the invention is also suitable for detecting an image, or a portion of an image, protected by one or more copyright agreements in the stream of graphic data exchanged daily on the Internet, particularly by peer-to-peer protocols.

Advantageously, according to the invention, for each listed index in said list,
said image associated with this listed index is sent to a device for reading and analyzing this image if said comparator has determined that the distance between this listed index and said reference index is below said predetermined threshold,
a signaling device, associated with a man-machine interface, is activated to alert a user to the recognition of said searched-for image in said image bank if said comparator has determined that said distance between this listed index and said reference index is below said predetermined threshold.

A method according to the invention requires the creation of an index list on the basis of which distances between each listed index and the reference index are evaluated in order to detect a distance below a predetermined threshold.

In a variant of the invention, as soon as a distance below a predetermined threshold is detected, a signaling device is activated in order to enable a user to be alerted to the recognition of the searched-for image. Similarly, as soon as a distance below the predetermined threshold is detected, the corresponding image from the image bank is read by a reading and analysis device. This reading and analysis device can be of any type. In a variant of the invention, it can be adapted to display the selected image, or to extract data therefrom, such as the name of the image, the memory location of the image, or the like. This reading and analysis device may comprise a microprocessor. Similarly, a signaling device can be of any type. In particular, it may comprise a microprocessor adapted to send an audible signal as soon as a successful recognition has taken place, or to display a message on a screen.

A method according to the invention in which each image is associated with an index generated according to the indexing method described above can be used to measure the similarity between this image, or portion of image, and a reference image which comprises a graphical pattern. For this purpose, a measurement of similarity, called the distance, between the index of this image and the index of the reference image is determined. This distance is then sent to a comparator which compares it with a predetermined threshold.

Any type of comparator can be used. Similarly, any type of similarity measurement can be determined. It may be a distance in the mathematical sense of the term, or another type of measurement. For example, it may be a known Euclidean distance, a Manhattan distance, a quadratic distance, etc.

Advantageously, however, according to the invention, the similarity measurement, called the distance, between a listed index and said reference index is determined by steps in which
said distance is initialized to m×n,
for each element (i,j), iε[1,m], jε[1,n] of said reference index, the value of this element is compared with the value of the element (i,j) of said listed index and said distance is decremented by 1 if these values are equal.

Thus, for any index according to the invention which has the dimensions m×n, a measurement of the distance between two indices equal to m×n is representative of two indices which are remote from each other. Conversely, a distance measurement of zero represents two identical indices.

In this sense, a similarity measurement according to this variant of the invention is a metric distance; in other words, it meets the conditions of symmetry, separation and triangle inequality. Throughout the following text, this similarity measurement in this variant of the invention is referred to as the metric distance, according to the invention.

In another embodiment, however, the similarity measurement, called the distance, between a listed index and the reference index can be produced by initializing the distance to 0 and incrementing the value of the distance by 1 as soon as the value of an element (i,j), iε[1,m], jε[1,n] of the reference index is equal to the value of the element (i,j) of the listed index. In this case, a measurement of distance between two indices equal to m×n represents two identical indices, and a measurement of distance equal to zero represents two indices which are remote from each other.

In this case, an image associated with a listed index is sent to the device for reading and analyzing this image if said distance is greater than the predetermined threshold, and the signaling device associated with the man-machine interface is activated to alert a user to the recognition of the searched-for image in said image bank if said distance is greater than the predetermined threshold.

Throughout the following text, this measurement of similarity between two indices is called the non-metric distance according to the invention.

A user can specify different thresholds for the measurement of similarity between two images.

However, if a metric distance according to the invention is used, said predetermined threshold is advantageously in the range from 0 to (m×n)/p.

If a non-metric distance according to the invention is used, the predetermined threshold is advantageously in the range from (m×n)/p to m×n.

According to the invention, since each of the m×n elements of an index can take one value out of p values, the probability that two random indices will be identical is (m×n)/p. Consequently, a threshold in the range from 0 to (m×n)/p, if a metric distance according to the invention is used, represents a significant similarity between the two associated images.

A method according to the invention and an indexing method according to the invention advantageously comprise a step in which p processes are carried out on the image normalized by p operators.

These processes are carried out by a processing module, which is advantageously implemented in a microcomputer.

For this step, any type of operator can be used. The operators may be of the type designed to emphasize one or more characteristics of the normalized image.

Advantageously, however, according to the invention, each of the p processes performed on a normalized image by a mathematical operator to provide a characteristic image is adapted to carry out a spatial filtering of the normalized image.

Spatial filtering of a normalized image is a suitable method for augmenting certain contrasts of the image, for detecting profiles or, conversely, for reducing variations within the image. It may take the form of spatial filtering of the high-pass type, intended to emphasize variations of light, low-pass filtering intended to attenuate variations of light, or bandpass filtering.

The operators according to the invention can be chosen for the purpose of carrying out directional filtering, in other words emphasizing variations of intensity along predetermined vertical, horizontal or diagonal axes.

Spatial filtering is advantageously carried out by convolution filters, in other words those using a convolution between said normalized image and a predetermined convolution matrix.

Advantageously, according to the invention, each convolution matrix is chosen from Sobel matrices, Prewitt matrices, Sigma matrices, Roberts matrices, Laplacian matrices, and gradient matrices.

A method for searching and recognition according to the invention and an indexing method according to the invention advantageously comprise a step in which each characteristic image is reduced to provide an image, called the reduced image, having the dimensions m×n, said reduced image being generated by replacing each sub-image of this characteristic image with at least one value, called the representative value of this sub-image, determined as a function of the c×d pixels of this sub-image.

Advantageously and according to the invention, said value representing a sub-image of dimension c×d is the value of the pixel of this sub-image which has the maximum value.

A searching and recognition method according to the invention and an indexing method according to the invention advantageously comprise a step in which a function, called the selection function, is determined to enable at least one value, called the selected value, to be chosen from p values.

Advantageously and according to the invention, said function for selecting a selected value from p values is adapted to select the maximum value of these p values.

Advantageously and according to the invention, p is greater than 6, being in the range from 6 to 128 for example.

By using a large number of operators it is possible to generate a large number of characteristic images, and especially to assign a wide range of possible values to each element of each index, each element being able to take an whole number value in the range from 1 to P.

On the other hand, a small number of operators allows a faster calculation speed, since fewer characteristic images have to be generated.

Additionally, since p defines the number of values that can be taken by an element of an index generated by an indexing procedure according to the invention, a large value of p implies that a similarity between two indices cannot be detected unless the two images from which they have been derived are virtually identical, whereas a small value of p enables us to match two images whose similarity makes less allowance for the details.

The value of p is therefore advantageously adapted to the objective of the application (for example, searching for an image in the image bank that is strictly identical to the searched-for image, searching for a generally similar image, etc.)

The experiments conducted by the inventors have shown that values of p in the range from 6 to 128 yield good results, in respect of all the objectives considered overall. However, there is no reason why a larger number of operators should not be used for certain specific applications.

Similarly, the sizes of the indices can be chosen and adapted to the types of images contained in the image bank in which the search is carried out.

A method according to the invention implemented by a microcomputer having a mass memory for storing the indices requires (m×n)×log₂ p bits per index.

The values of p, n and m are advantageously chosen in such a way that the space occupied by an index in the memory of a computer device is compatible with the hardware constraints and also with the desired performance.

For a value of p equal to 8, and in order to obtain indices for which the memory space occupied is about 18 bytes, the product m×n should be about 7×7.

Advantageously and according to the invention, n and m are greater than 6, being in the range from 6 to 20 for example.

However, there is no reason not to use other values for certain specific applications.

Similarly, the whole numbers c and d can have different values.

Advantageously and according to the invention, the whole numbers c and d are equal, and consequently the sub-images of each characteristic image are squared.

Advantageously and according to the invention, c and d are greater than 2, being in the range from 2 to 5 for example.

However, there is no reason not to use other values for specific applications.

A method for searching for and recognizing an image in an image bank according to the invention and an indexing method according to the invention can generate indices of the image bank before generating the index of the searched-for image, or can generate the index of the searched-for image before generating the indices of the image bank.

In the latter case, the listed indices of the image bank can be generated by a batch process before the determination of the distances between the listed indices and the reference index, or can be generated as the processing of the image bank proceeds. This architecture is particularly suitable for dynamic image banks which develop over time, such as image banks obtained and continually enriched by downloading from the Internet or by acquisition via broadcasting.

A method according to the invention is therefore particularly adapted to searching for and recognizing an image comprising a specific graphical pattern in a stream of images.

A method according to the invention is also suitable for generating the index list of the image bank and storing this index list of the image bank in a mass memory before the generation of an index of a searched-for image. This makes it possible, for example, to dissociate in time the steps of the creation of one or more index lists of one or more image banks from the steps of recognizing a searched-for image among these one or more image banks.

A method according to the invention is also suitable for searching for an image or a sequence of images in a plurality of video sequences.

In this case, advantageously and according to the invention, the reading by the reading and analysis device of the digital image associated with the listed index for which the distance with respect to said reference index is below the predetermined threshold comprises a step in which attributes of the video sequence comprising this image, such as the name of the sequence or the type of sequence, are sent to a man-machine interface.

A method according to the invention is also suitable for searching for a subliminal flash image inserted into a video sequence.

For this purpose, advantageously and according to the invention, said searched-for image is a subliminal flash image inserted into a video sequence, and said image bank is this video sequence.

The invention also relates to a method for searching for and recognizing an image among a plurality of images, characterized in combination by some or all of the features mentioned above or below.

Other characteristics, objects, and advantages of the invention will be revealed by the following description, provided solely by way of non-limiting example, with reference to the attached drawings, in which:

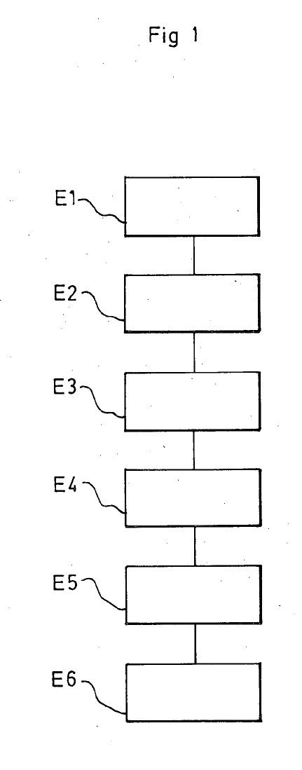

FIG. 1 is a schematic view of a method for searching for and recognizing an image in an image bank according to the invention,

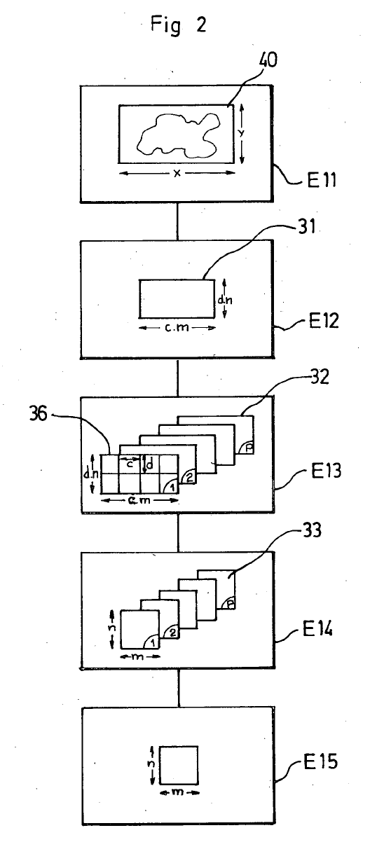

FIG. 2 is a schematic view of a method for indexing an image according to one embodiment of the invention,

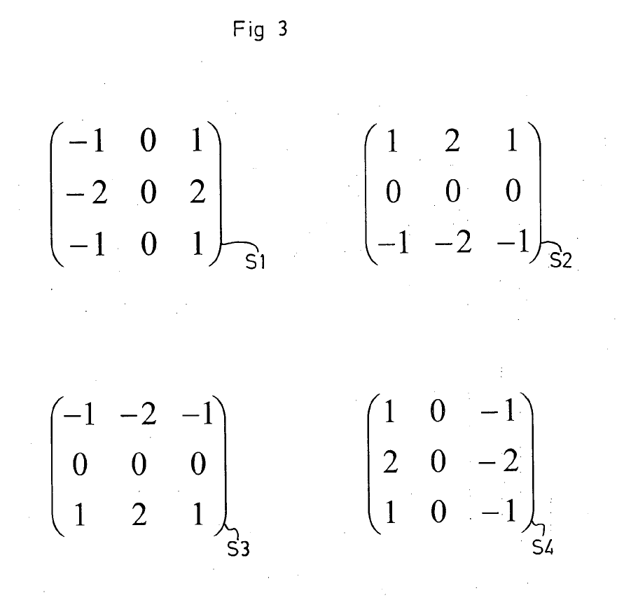

FIG. 3 is a schematic view of spatial filters forming operators for processing digital image according to one embodiment of the invention,

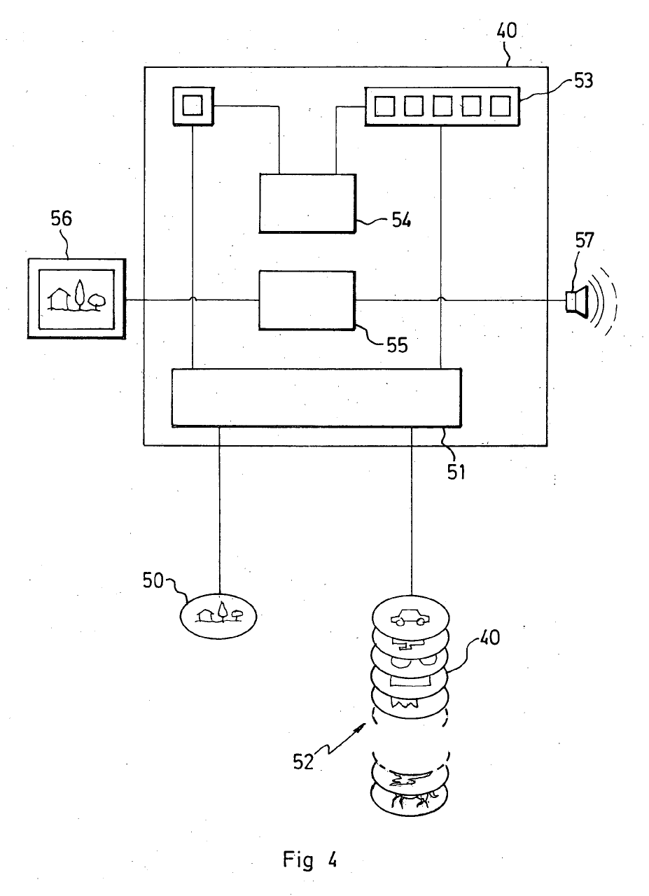

FIG. 4 is a schematic view of a device suitable for implementing a method according to the invention,

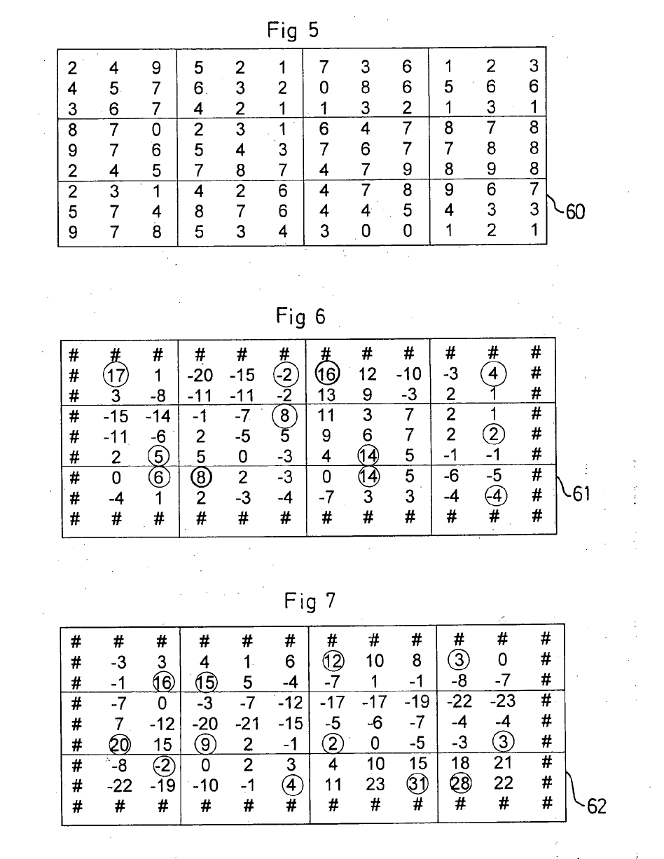

FIG. 5 is a schematic matrix representation of an example of a normalized image,

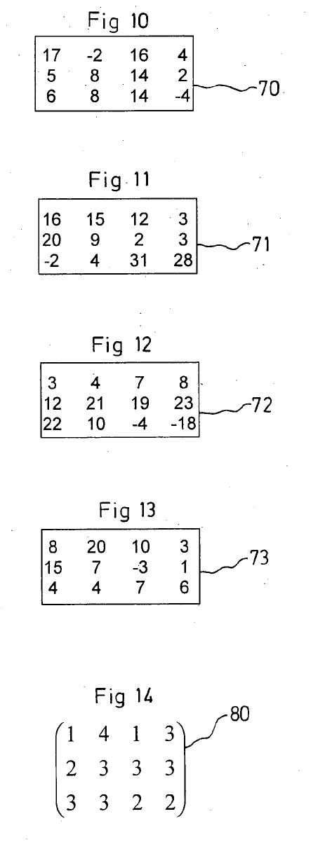

FIGS. 6 to 14 are schematic matrix representations of digital images obtained by an indexing method according to the invention from the normalized image of FIG. 5.

As shown in FIG. 1, a method according to the invention for searching for an image, called the searched-for image, among a plurality of images, called an image bank, comprises a step E1 in which an index, called the reference index, is associated with said searched-for image.

A method according to the invention also comprises a step E2 in which an index, called the listed index, is associated with each image of said image bank. This step E2 also comprises a stage of sending each listed index to an index list. This index list may, for example, be stored in a random access memory or a mass memory of a computer device, such as a microcomputer.

The steps E1 and E2 may be executed in any order.

A method according to the invention also comprises a step E3 for the determination of a measurement of similarity, called the distance, between the listed indices of the index list and the reference index. This step E3 also comprises a stage of sending the determined distance to a comparator.

A method according to the invention also comprises a step E4 for comparing the determined distance with a predetermined threshold. This comparison step serves to determine whether or not the determined distance is greater than a predetermined threshold.

In an advantageous embodiment of the invention, the distance determined in step E3 is a metric distance, in other words a distance with a value of zero represents two identical indices.

In this case, if the step E4 has shown that the distance between a listed index and the reference index is below the predetermined threshold, the method according to the invention comprises a step E5 of sending the image associated with the listed index for which the distance determined with respect to the reference index is below the predetermined threshold to a device for reading and analyzing this image, and a step E6 of activating a signaling device adapted to alert an operator to the fact that the searched-for image has been found in said image bank.

The steps E2, E3, E4, E5 and E6 can be executed sequentially for each image of the image bank in such a way that the recognition of a searched-for image in the image bank can be signaled to an operator before the full processing of the image bank. This is particularly useful if the objective of the processing is to search for a single copy of said searched-for image in the image bank.

However, in another embodiment, the whole image bank is processed at each step before the execution of the next step. Thus each of the steps E2, E3, E4, E5 and E6 provides all the data required for the next step, before the execution of the next step.

In a preferred embodiment of the invention, as shown in FIG. 2, a listed index is generated directly for each digital image of the image bank from the data of this digital image. Thus each listed image directly represents the image with which it is associated. In a preferred embodiment of the invention, this method of creating an index from an image comprises the following steps.

In a first step E11, the digital image associated with this index is sent to a unit for processing this image. This digital image has the dimensions x×y, where x and y are any whole numbers which are specific to each image.

This digital image is resampled in a second step E12 into another digital image, called the normalized image, which has the dimensions c.m×d.n, where c, d, m and n are predetermined whole numbers.

This normalization of the image is carried out by a resampling module. This module can be positioned locally, in a microcomputer for example, or remotely. This resampling module is advantageously formed by software means.

Thus all the images normalized by the resampling module have the same dimensions.

The normalization of an image can also comprise, in a known way, a step of converting a color image having a plurality of color levels into an image with gray levels.

The values of the whole numbers m and n can be chosen at will. However, as mentioned below, the index constructed from an image has the dimensions m×n.

Therefore, in order to obtain an index which is not too bulky, but which is still representative of the image with which it is associated, the inventors have found from experience that values of m and n of about 7 generally yield satisfactory results.

In a subsequent third step E13, the normalized image is processed by p mathematical operators indexed from 1 to p, to provide p digital images, called characteristic images, where p is a predetermined whole number.

Each operator is applied to the normalized image to provide a corresponding characteristic image.

In an advantageous embodiment of the invention, as shown in FIG. 2, each characteristic image generated in this way is itself indexed by the index of the operator from which it is derived.

Each characteristic image generated in this way has the dimensions c.m×d.n and is formed by m×n sub-images, each sub-image having the dimensions c×d.

Any type of mathematical operator may be used. However, in one embodiment of the invention, each of the p mathematical operators is an operator for the spatial filtering of the normalized image.

Spatial filtering enables the value of a pixel to be modified proportionally to the variations of luminous intensity of the neighboring pixels. Spatial filtering can also be sensitive to the presence or absence of these variations in luminous intensity. This enables certain discriminatory characteristics of the image to be emphasized.

In different embodiments of the invention, the operators can be high-pass filters, low-pass filters or bandpass filters. These filters can be linear filters, in which the value of a pixel of the characteristic image is a linear combination of the values of the neighboring pixels, or non-linear filters.

These spatial filtering operators can be known operators such as Prewitt filters, Sobel filters, Roberts filters, and the like, or dedicated operators.

These processing operations are carried out by a processing module. This processing module can be positioned locally, in a microcomputer for example, or remotely. This processing module is advantageously implemented by software means.

In one embodiment, p is set at 4, in such a way that each normalized image is processed by 4 operators. Clearly, in other embodiments, each normalized image can be processed by a smaller or a larger number of operators.

In one embodiment, the operators are convolution operators represented by convolution kernels expressed in the form of convolution matrices. In one embodiment, these matrices are Sobel matrices as shown in FIG. 3. These operators can be used to emphasize the variations of intensity along the vertical axis and along the horizontal axis of the normalized image.

If we consider an embodiment of this kind in which p is set to 4, the first indexed operator can be represented by the matrix S1, known as a horizontal Sobel matrix. The second indexed operator can be represented by the matrix S2, known as a vertical Sobel matrix. The third indexed operator can be represented by the matrix S3, transposed from the matrix S1. The fourth indexed operator can be represented by the matrix S4, transposed from the matrix S2.

Thus four characteristic images are obtained from each normalized image, each characteristic image highlighting certain horizontal or vertical characteristics of the image.

Each of the characteristic images generated by the step E13 is subsequently reduced in a step E14 to provide an image, called the reduced image.

Each image reduced by the step E14 has the dimensions m×n. This reduced image is generated by replacing each of the m×n sub-images of the characteristic image from which it is derived by a value, called the representative value of this sub-image, determined as a function of the c×d pixels of this sub-image.

In one embodiment the value representing each sub-image is the mean of the values of the c×d pixels of this sub-image. In another embodiment, the value representing each sub-image is the median of the values of the c×d pixels of this sub-image. Any type of function can be used to determine a representative value of each sub-image.

In another embodiment, the value representing each sub-image is the value of the pixel of this sub-image which has the maximum value. Each of the m×n pixels of a reduced image is therefore the pixel of maximum value of the c×d pixels of the sub-image from which it is derived.

The inventors have found by experience that this representative value enables satisfactory results to be obtained without the use of complicated calculations that consume large resources.

In a final step, E15, a function, called the selection function, is determined to enable at least one value, called the selected value, to be selected from among p values.

This function is used to generate the index of the initial image. The index has the dimensions m×n.

Each element (i,j), iε[1,m], jε[1,n], of this index has as its value the index of the process which produced the reduced image comprising the value selected by said selection function applied to the p pixels (i,j) of the p reduced images.

Each element (i,j), iε[1,m], jε[1,n] of the created index can thus have a value taken from the set {1, 2, . . . , p}. The value of this element is determined by the selection function applied to the p elements (i,j) of the p reduced images.

In an advantageous embodiment of the invention, the function for selecting a selected value from among p values selects the maximum value.

Consequently, for example, if p is set to 4, each element of the created index can have a value taken from the set {1, 2, 3, 4}. If, for a given element (i,j), the value of the corresponding element (i,j) of the reduced image derived from the 3rd operator is the maximum of the corresponding 4 values (i,j), the element (i,j) of the index will have the value 3.

In other words, the index constructed by a method according to the invention comprises the indices of the operators. Each element of the index indicates the operator which was used to find the maximum value in a given region of the normalized image.

The inventors have found that this method can yield excellent results in terms of speed of calculation and discrimination between the indices, and consequently between the images.

Moreover, if m is set to 7, n is set to 8, and p is set to 8, each index occupies (m×n)×log₂ p bits, in other words 21 bytes.

Therefore the indexing of one hour of broadcast programs, such as those broadcast by the Eutelsat system, requires about 1.8 MB of memory space. Such an index file is a thousand times more compact than the same video file in MPEG2 format.

Moreover, the construction of an index in this way makes it possible to generate p(m×n) different indices, or in other words, based on the aforementioned values, about 1050 different indices, in other words considerably more than the quantity of digital data generated throughout the world each year, which is estimated to be 10 exabytes.

According to the invention, the reference index is generated from the reference image by the same steps as those used to generate the listed indices.

A specific example of the creation of an index from a digital image is given below, based on the diagrams in FIGS. 5 to 14.

In this example, m, n, c and p are equal to 4, 3, 3 and 4 respectively.

FIG. 5 is a schematic matrix representation of a normalized image 60. This normalized image 60 has the dimensions 12×9.

FIG. 6 is a schematic matrix representation of a characteristic image 61 obtained by convolution of the normalized image 60 of FIG. 5 with a first operator such as that represented by the matrix S1 of FIG. 3.

FIG. 7 is a schematic matrix representation of a characteristic image 62 obtained by convolution of the normalized image 60 of FIG. 5 with a second operator such as that represented by the matrix S2 of FIG. 3.

FIG. 8 is a schematic matrix representation of a characteristic image 63 obtained by convolution of the normalized image 60 of FIG. 5 with a third operator such as that represented by the matrix S3 of FIG. 3.

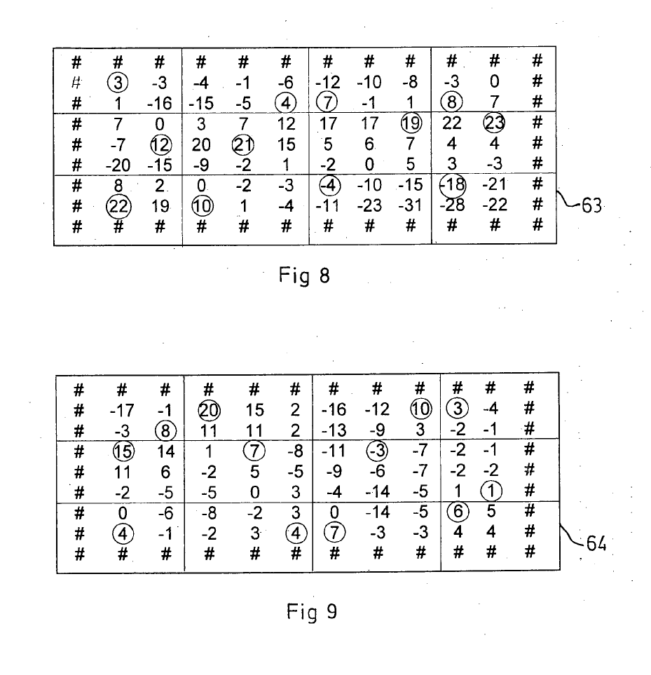

FIG. 9 is a schematic matrix representation of a characteristic image 64 obtained by convolution of the normalized image 60 of FIG. 5 with a fourth operator such as that represented by the matrix S4 of FIG. 3.

Each of the characteristic images 61, 62, 63, 64 is obtained by convolution of the normalized image 60 by a convolution matrix having the dimensions 3×3. Consequently, the marginal pixels of each of these characteristic images cannot be calculated. These non-calculable values are represented by the symbol “#” in FIGS. 6, 7, 8 and 9.

Each of the characteristic images 61, 62, 63, 64 obtained in this way is reduced in step E13 to provide a reduced image. For this purpose, each sub-image of dimension 3×3 of each characteristic image is replaced by the maximum value of this sub-image. Clearly, the non-calculable values represented by the symbol “#” are not taken into account for the determination of the maximum value of this sub-image.

FIGS. 10, 11, 12 and 13 are schematic representations of the reduced images 70, 71, 72, 73 obtained, respectively, from the characteristic images 61, 62, 63, 64 of FIGS. 6, 7, 8 and 9. The pixel with the maximum value of each sub-image of each characteristic image is circled for the sake of clarity in FIGS. 6 to 9.

The index 80 is then obtained by step E15, by allocating to each element (i,j), iε[1,4], jε[1,3] of this index 80 the index of the operator which was used to produce the reduced image, comprising the maximum value of the 4 pixels (i,j) of the 4 reduced images.

For example, for the allocation of a value to the element (1, 1) of the index 80, the reduced image which has the maximum element (1, 1) is identified. In this example, the element (1, 1) of the reduced image 70 of FIG. 10 has the maximum value. This reduced image 70 has been found by reducing the characteristic image 61 which resulted from the processing of the image 60 normalized by the first operator. Consequently this element (1, 1) has the value “1”. On the other hand, for the allocation of a value to the element (4, 3) of the index (80), it is ascertained that, out of all the elements (4, 3) of the images 70, 71, 72 and 73, the element having the maximum value belongs to the reduced image 71 derived from the characteristic image 62, which was itself obtained by the second process. The element (4, 3) of the index 80 therefore takes “2” as its value.

The schematic index of FIG. 5 can therefore be indexed, by an indexing method according to the invention, by the index as represented in FIG. 14.

According to the invention, and as shown in FIG. 1, after the indices have been created a distance between each listed index and the reference index is determined in step E3.

In one embodiment of the invention, the distance D between a reference index I ref of dimension m×n and a listed index I rep of dimension m×n is calculated by the following steps:
initializing the distance D to m×n,
for each element (i,j), iε[1,m], jε[1,n] of said reference index I ref, the distance D is decremented by 1 if the value of this element is equal to the value of the element (i,j) of said listed index I rep.

Consequently, a distance of zero represents two identical indices, whereas a distance close to m×n represents two indices remote from each other.

The distance D calculated in this way is sent to a comparator adapted to compare this distance with a threshold S in a step E4.

Any type of comparator can be used to implement the method according to the invention. It may be a software comparator, for example a comparator formed by a microprocessor and a rapid-access memory.

This predetermined threshold S is preferably set to a value between 0 and (m×n)/pin this embodiment. As the threshold approaches 0, the recognition becomes more precise.

If the distance D is below the threshold S, the searched-for image from which the reference index I ref was derived is visually similar to the image in the image bank from which the listed image I rep was derived.

According to the invention, if this recognition has taken place, the image in the image bank from which this listed index I rep, hereinafter referred to as “the detected image”, was produced is sent to a device for reading and analyzing this image.

This reading and analysis device can be of any type. It can comprise means of displaying this image in such a way that an operator can validate or reject the completed recognition if necessary. This reading and analysis device can if necessary comprise means for the specific processing of this image for the purpose of extracting other characteristics of the image.

Moreover, according to the invention, if this recognition has taken place, a signaling device, associated with a man-machine interface, is activated to notify a user of the recognition of said searched-for image in said image bank.

This signaling device can comprise means of displaying the detected image. This signaling device can be formed, as a general rule, by any type of device suitable for alerting an operator to a successful recognition.

A method according to the invention can be implemented by a microcomputer, for example a microcomputer having a 2 GHz processor.

A device of this kind is shown schematically in FIG. 4. An image 50 is stored in the memory of a microcomputer 40. This image 50 may be stored by any known means, for example by reading the image from an external memory device, and transferring the image to a mass memory of the microcomputer. This image 50 is adapted to be sent to a central processing unit 51 via a communication bus of a known type. An image bank 52 is also adapted to be sent to the central processing unit 51. The link between the image bank and the processing unit 51 can be of any type. For example, it may be an Internet link using known protocols. In this embodiment, the central processing unit 51 comprises a module for resampling an image and a module for processing a normalized image. The processing unit 51 comprises, in a known way, a microprocessor, and is associated with at least one mass memory which can hold one or more computer programs and at least one random-access memory adapted to store temporary data. The mass memory is adapted to contain a computer program adapted to implement and execute the steps of the indexing method according to the invention. This program is written by known methods of instruction coding. It can then be used to generate a reference index I ref, from the image 50, and stores this index in a memory space of the random-access memory or the mass memory. This program is also written in such a way that it can generate the indices I rep of each image in the image bank 52 and store them in an index list 53 recorded in a mass memory or in a random-access memory. Each index I rep and the index I ref are processed by a computer program 54 stored in the mass memory of the microcomputer in order to obtain a measurement of the similarity between these indices. This similarity measurement, called the distance, is sent to a comparator 55, which can be formed by software means stored in a memory of the microcomputer. This comparator is adapted to compare the received distance with a predetermined threshold. This predetermined threshold can be stored in the random-access memory or the read-only memory of the microcomputer. If the comparator finds a metric distance according to the invention which is below the predetermined threshold, the central processing unit 51 is adapted to activate a device 57 for signaling a successful recognition, this device possibly being implemented in the form of a device for emitting an audible signal, such as a microcomputer loudspeaker. The central processing unit 51 also sends the detected image to a device for reading and analyzing this image, for the purpose of extracting data from the image, such as its name, size, etc., in order to supply these data to an operator, via a screen for example. This reading and analysis device can also comprise means 56 for displaying this image.

Clearly, a method for searching and recognition according to the invention and an indexing method according to the invention can be implemented by means other than the data processing means described.

A method of searching for and recognizing an image among a plurality of images according to the invention makes it possible to achieve hitherto unequalled performance levels in terms of processing speed and successful detection, and provides opportunities for the development of a wide range of new applications.

In particular, a method according to the invention makes it possible to search for and recognize a subliminal digital image in a video sequence.

A method according to the invention also makes it possible to search for and recognize a digital image representing a pattern protected by at least one copyright agreement among a stream of digital images.

1-17. (canceled)

18. A method of fast searching and recognition of a predetermined digital image, called the searched-for image, representing at least one graphic pattern, among a plurality of digital images, called the image bank, in which:
(E1) an index, called the reference index, is associated with said searched-for image,
(E2) for each image of said image bank, an index, called the listed index, is associated with this image and is sent to an index list,
for each listed index in said index list,
(E3) a measurement of the similarity,
called the distance, between this listed index and said reference index is determined and sent to a comparator,
(E4) said determined distance is compared with a predetermined threshold by said comparator in order to determine whether the image associated with this listed index is similar, according to said comparison threshold, to said searched-for image,
wherein each index (listed and reference) is a two-dimensional matrix of dimensions m×n, where m and n are predetermined integers, generated by the following steps:
(E12) the digital image associated with this index is sent to a module for resampling this image, adapted to provide a digital image, called the normalized image, having dimensions c.m×d.n, where c and d are predetermined whole numbers,
(E13) said normalized image is sent to a module for processing this image, adapted to carry out p processes, indexed from 1 to p, on the normalized image by p predetermined mathematical operators (S1, S2, S3, S4), to provide p digital images, called characteristic images, p being a predetermined whole number, each characteristic image being composed of m×n sub-images, each sub-image having the dimensions c×d,
(E14) each characteristic image is reduced to provide an image, called the reduced image, having the dimensions m×n, said reduced image being generated by replacing each sub-image of this characteristic image by at least one value, called the representative value of this sub-image, determined as a function of the c×d pixels of this sub-image,
a function called the selection function is determined, to enable at least one value, called the selected value, to be selected from p values,
(E15) each element (i,j), iε[1,m], jε[1,n] of this index is given the index of the process which produces the characteristic image from which is obtained the reduced image which comprises said value selected by said selection function applied to the p pixels (i,j) of the p reduced images (33).

19. The method as claimed in claim 18, wherein, for each listed index of said index list,
(E5) said image associated with this listed index is sent to a device for reading and analyzing this image if said comparator has determined that the distance between this listed image and said reference index is below said predetermined threshold,
(E6) a signaling device, associated with a man-machine interface, is activated to alert a user to the recognition of said searched-for image in said image bank if said comparator has determined that said distance between this listed index and said reference index is below said predetermined threshold.

20. The method as claimed in claim 18, wherein said distance between a listed index and said reference index is determined by the steps in which:
said distance is initialized to m×n,
for each element (i,j), iε[1,m], jε[1,n] of said reference index, the value of this element is compared with the value of the element (i,j) of said directory index and said distance is decremented by 1 if these values are equal.

21. The method as claimed in claim 20, wherein said predetermined threshold is in the range from 0 to (m×n)/p.

22. The method as claimed in claim 18, wherein each of the p processes carried out on a normalized image by a mathematical operator to provide a characteristic image is adapted to carry out a spatial filtering of the normalized image.

23. The method as claimed in claim 22, wherein each convolution matrix is chosen from Sobel matrices, Prewitt matrices, Sigma matrices, Roberts matrices, Laplacian matrices, and gradient matrices.

24. The method as claimed in claim 18, wherein said value representing a sub-image of dimension c×d is the value of the pixel of this sub-image which has the maximum value.

25. The method as claimed in claim 18, wherein said function for selecting a selected value among p values is adapted to select the maximum value of these p values.

26. The method as claimed in claim 18, wherein p is greater than 6, being for example in the range from 6 to 128.

27. The method as claimed in claim 18, wherein n and m are greater than 6, being for example in the range from 6 to 20.

28. The method as claimed in claim 18, wherein the whole numbers c and d are equal, and consequently the sub-images of each characteristic image are squared.

29. The method as claimed in claim 18, wherein c and d are greater than 2, being for example in the range from 2 to 5.

30. The method as claimed in claim 18, wherein said listed indexes in said image bank are determined before the determination of said reference index of said searched-for image.

31. The method as claimed in claim 18, wherein said image bank is a stream of images.

32. The method as claimed in claim 18, in which said image bank comprises a plurality of video sequences, each video sequence comprising at least one attribute representing this sequence, wherein the reading by said reading and analysis device of a digital image associated with a listed index whose distance from said reference index is below the predetermined threshold comprises a step in which at least one attribute of the video sequence comprising this image is sent to a man-machine interface.

33. The method as claimed in claim 18, wherein each index is adapted to be stored in a mass memory unit in less than 128 bytes, for example less than 64 bytes.

34. The method as claimed in claim 18, wherein said searched-for image is a subliminal flash image inserted into a video sequence and wherein said image bank is this video sequence.
